(19) United States
(12) Patent Application Publication
(10) Pub. No.: US 2024/0079665 A1
(43) Pub. Date: Mar. 7, 2024

(54) Battery Pack Device and Battery Pack

(71) Applicant: Robert Bosch GmbH, Stuttgart (DE)

(72) Inventor: Florian Kneer, Duernau (DE)

(21) Appl. No.: 18/456,902

(22) Filed: Aug. 28, 2023

(30) Foreign Application Priority Data
Sep. 1, 2022 (DE) 10 2022 209 093.4

(51) Int. Cl. H01M 10/48; G01K 1/16; H01M 10/42; H01M 10/613; H01M 10/647; H01M 10/6555; H01M 50/211; H01M 50/284

(52) U.S. Cl. CPC H01M 10/486; G01K 1/16; H01M 10/425; H01M 10/482; H01M 10/613; H01M 10/647; H01M 10/6555; H01M 50/211; H01M 50/284; H01M 2220/30

(57) ABSTRACT

A battery pack device for a battery pack, in particular a pouch cell battery pack, includes at least one heat conducting element which has at least one battery cell contact section for arrangement on at least one battery cell, preferably between two battery cells, of the battery pack and for dissipating heat from the at least one battery cell. The battery pack device further includes at least one temperature measuring unit, which has at least one temperature sensor element thermally coupled to the heat conducting element. The temperature sensor element is arranged outside the battery cell contact section of the heat conducting element.

This application claims priority under 35 U.S.C. § 119 to application no. DE 10 2022 209 093.4, filed on Sep. 1, 2022 in Germany, the disclosure of which is incorporated herein by reference in its entirety.

### BACKGROUND

A battery pack device for a battery pack, comprising at least one heat conducting element having at least one battery cell contact section for arrangement on at least one battery cell of the battery pack and for dissipating heat from the at least one battery cell, and at least one temperature measuring unit having at least one temperature sensor element thermally coupled to the heat conducting element, has already been proposed.

### SUMMARY

The disclosure is based on a battery pack device for a battery pack, in particular a pouch cell battery pack, having at least one heat conducting element which has at least one battery cell contact section for arrangement on at least one battery cell, preferably between two battery cells, of the battery pack and for dissipating heat from the at least one battery cell, and having at least one temperature measuring unit which has at least one temperature sensor element which is thermally coupled to the heat conducting element.

It is proposed that the temperature sensor element is arranged outside the battery cell contact section of the heat conducting element. By designing the battery pack device according to the disclosure, a particularly compact design of the battery pack device can be advantageously achieved. Advantageously, the design of the battery pack device according to the disclosure can at least partially dispense with additional elements such as plugs and cables for temperature measurement. Advantageously, a structurally particularly simple design of the battery pack device, in particular of the battery pack comprising the battery pack device, can be realized. Thus, a susceptibility to error of the battery pack device can be advantageously reduced. Furthermore, a particularly high reliability and quality of the battery pack device can be advantageously achieved. Advantageously, damage caused by the temperature measuring unit, which can be generated when positioning the temperature sensor element between the battery cells during operation or due to inadequate mounting, can be avoided. Advantageously, a particularly high level of operational reliability can be achieved. Advantageously, the temperature of the battery cells can be monitored particularly easily, especially at low cost, and precisely. Advantageously, a service life of the battery cells can be increased.

The heat conducting element is preferably of plate-like design. Preferably, the heat conducting element is designed as a cooling plate, in particular as a cooling sheet. Alternatively, however, it is also conceivable for the heat conducting element to be strip-like or wire-like or to have any other shape that appears reasonable to a person skilled in the art. In particular, the battery cell contact section has at least one battery cell contact surface which preferably abuts the battery cell in at least one operating state. Preferably, the battery cell contact section has two battery cell contact surfaces, which, in particular, in at least one state of the heat conducting element arranged between the two battery cells of the battery pack, are each in contact with one of the two battery cells. It is conceivable that the battery pack has only the battery cell, the two battery cells, or more than two battery cells. The at least one battery cell of the battery pack is designed in particular as a pouch cell. For example, the battery pack device has only the heat conducting element or a plurality of heat conducting elements. It is conceivable that the temperature measuring unit comprises only the temperature sensor element or a plurality of temperature sensor elements. Preferably, a plurality of heat conducting elements corresponds to a plurality of temperature sensor elements. Preferably, one of the temperature sensor elements is associated with each of the heat conducting elements. Alternatively, however, it is also conceivable that the plurality of heat conducting elements is smaller or larger than the plurality of temperature sensor elements.

The temperature measuring unit preferably has a computing unit. In particular, the computing unit is connected to the at least one temperature sensor element for signal transmission, preferably by cable. The computing unit is preferably provided for determining a temperature of the battery cell arranged on the heat conducting element as a function of a sensor signal of the at least one temperature sensor element. “Provided” is to be understood as meaning specifically configured, specifically designed and/or specifically equipped. When an object is provided for a particular function, this is to be understood as meaning that the object fulfills and/or performs that particular function in at least one application and/or operating state. In particular, the computing unit comprises at least a processor and a storage element as well as an operating program stored on the storage element. The storage element is preferably designed as a digital storage medium, for example as a hard drive or the like.

In particular, the temperature sensor element is arranged at a distance from the battery cell in at least one operating state. The temperature sensor element is preferably spaced apart from the battery cell contact section of the heat conducting element. It is conceivable that the temperature sensor element is arranged at a distance from a main extension plane of the battery cell contact section. Alternatively, it is also conceivable that the main extension plane of the battery cell contact section intersects the temperature sensor element. A “main extension plane” of a unit or element can be understood as a plane which is parallel to a largest side surface of a smallest possible imaginary cuboid which just completely encloses the unit, and in particular runs through the center of the cuboid. Preferably, the battery cell contact section is free of sensor elements, in particular free of temperature sensor elements.

Furthermore, it is proposed that the battery pack device comprises a printed circuit board, in particular a flexible printed circuit board, which is arranged between the heat conducting element and the temperature sensor element. It is conceivable that the printed circuit board of the battery pack device at least partially comprises the computing unit. It is also conceivable that the battery pack device has another printed circuit board. The further printed circuit board is preferably connected to the printed circuit board of the battery pack device in terms of data. For example, the further printed circuit board at least partially comprises the computing unit. Preferably, the printed circuit board of the battery pack device and the further printed circuit board are arranged on different sides of the battery pack device. Alternatively, however, it is also conceivable that the printed circuit board of the battery pack device and the further printed circuit board are arranged on the same side. The further printed circuit board is preferably designed as a rigid printed circuit board. Alternatively, however, it is also conceivable that the further printed circuit board is designed as a flexible printed circuit board. In particular, the heat conducting element and the temperature sensor element are arranged on opposite sides of the printed circuit board of the battery pack device. Preferably, the temperature sensor element is spaced apart from the heat conducting element. In particular, the temperature sensor element is thermally coupled to the heat conducting element by means of the printed circuit board of the battery pack device. Alternatively, however, it is also conceivable that the heat conducting element and the temperature sensor element are arranged on the same side of the printed circuit board. In particular, it is alternatively conceivable that the temperature sensor element is arranged between the heat conducting element and the printed circuit board of the battery pack device. As an alternative to thermal coupling with the heat conducting element, the temperature sensor element is arranged directly on the heat conducting element, for example, by pressing or the like. Alternatively, however, it is also conceivable that the temperature sensor element is thermally coupled indirectly to the heat conducting element, for example by means of a heat conducting paste or the like. It is additionally conceivable that the printed circuit board of the battery pack device, which is designed as a flexible printed circuit board, is intended for use in a state-of-charge display, an SCM function (single cell monitoring function) or the like. Advantageously, the printed circuit board of the battery pack device can be used to transfer heat from the heat conducting element to the temperature sensor element.

It is further proposed that the battery pack device comprises a support unit for supporting a temperature measurement by the temperature measuring unit, wherein the support unit is arranged on a side of the printed circuit board of the battery pack device facing away from the heat conducting element. Preferably, the support unit and the temperature sensor element are arranged on the same side of the printed circuit board of the battery pack device. In particular, the support unit is provided for fixed positioning of the temperature sensor element relative to the printed circuit board of the battery pack device and/or the heat conducting element. In particular, the temperature sensor element is arranged between the heat conducting element and the support unit. Preferably, the heat conducting element and the support unit together at least substantially completely enclose the temperature sensor element in at least one operating state. By “at least substantially complete” may be meant at least 50%, preferably at least 75%, and more preferably at least 90% of a total volume and/or a total mass of an object. Advantageously, a reliable determination of the battery cell temperature can be supported. Advantageously, a particularly precise temperature determination can be achieved by means of the temperature sensor element.

It is further proposed that the support unit for generating a contact force for the temperature sensor element is elastic in the direction of the heat conducting element. The support unit has at least one support element. The support unit, in particular the support element, is preferably formed from a foam material. Alternatively, however, it is also conceivable that the support unit, in particular the support element, is formed from a rubber-elastic material or the like. The support element is preferably of plate-like design. Alternatively, however, it is also conceivable that the support element is circular-cylindrical, spherical, cuboidal, in particular cube-shaped, or the like. The support unit, in particular the support element, preferably has a modulus of elasticity between 0.1 MPa and 400 MPa. The battery pack device preferably has at least one housing unit. The heat conducting element, the battery cell, the temperature measuring unit and/or the support unit are in particular arranged at least substantially completely in the housing unit of the battery pack device. The support unit, in particular the support element, is preferably arranged between the housing unit, in particular a housing element of the housing unit, and the printed circuit board of the battery pack device. Advantageously, a structurally particularly simple fixation of the temperature sensor element relative to the heat conducting element can be realized.

It is also proposed that the support unit for thermally insulating the temperature sensor element from an external environment is thermally insulating. The support unit, preferably the support element, has in particular a thermal conductivity of maximum 0.3 W(K·m). In particular, the external environment is a side of the support unit facing away from the temperature sensor element. Advantageously, an undesired influence of an external environment on a temperature measurement by means of the temperature measuring unit can be counteracted. Advantageously, a particularly precise and reliable temperature determination of the battery cells can be realized.

Furthermore, it is proposed that the battery pack device comprises at least one cell holder for arranging the at least one battery cell, wherein the heat conducting element is partially overmolded in the cell holder. Preferably, the heat conducting element is partially overmolded by the cell holder by means of an injection molding process. It is conceivable that the battery pack device comprises only the cell holder or a plurality of cell holders. In particular, the heat conducting element has an exposed area in which the heat conducting element is preferably free from overmolding by the cell holder. In particular, the cell holder is arranged between the exposed area and the battery cell contact section. The cell holder is preferably arranged between the exposed area and the battery cell. Alternatively, it is also conceivable that the heat conducting element and the cell holder are formed in one piece, such as by manufacture from a casting and/or by manufacture in a single-component or multi-component injection molding process and advantageously from a single blank. Furthermore, it is also conceivable, as an alternative, that the heat conducting element is bonded to the cell holder by a welding process, an adhesive process and/or another process which appears to the skilled person to be sensible. Alternatively, however, it is also conceivable that the heat conducting element is arranged on the cell holder in a detachable manner, in particular in a non-destructively detachable manner. Preferably, the heat conducting element is formed of a metal, preferably aluminum or the like. Alternatively, however, it is also conceivable that the heat conducting element is formed from a plastic with a thermal conductivity of more than 0.3 W(K·m). Advantageously, a precise arrangement of the heat conducting element relative to the battery cell can be achieved particularly easily by design. Advantageously, a particularly efficient heat transfer from the battery cell via the heat conducting element can be realized. Advantageously, a particularly precise and reliable measurement of the temperature of the battery cell can be achieved.

Furthermore, it is proposed that the heat conducting element is designed to be exposed in a direction facing away from the at least one battery cell, in particular free of an encapsulation by the cell holder, with the temperature sensor element being arranged in the exposed area of the heat conducting element. In particular, the printed circuit board of the battery pack device is arranged in the exposed area of the heat conducting element. The exposed area is preferably spaced apart from the battery cell and/or the battery cell contact section in at least one operating state. Advantageously, a particularly efficient heat transfer can take place from the heat conducting element to the temperature sensor element. Advantageously, a particularly precise determination of the temperature of the battery cell can be made.

Furthermore, it is proposed that the heat conducting element has an edge area at which the temperature sensor element is arranged. The edge area is preferably arranged outside the battery cell contact section. Preferably, the exposed area of the heat conducting element is arranged in the edge area of the heat conducting element. Advantageously, a particularly simple assembly and disassembly of the temperature sensor elements can take place. Advantageously, a particularly convenient maintenance of the battery pack device can be realized. Advantageously, damaged temperature sensor elements can be replaced with particularly little effort.

It is further proposed that the temperature sensor element is arranged on an outer surface of the edge area. In particular, the exposed area of the heat conducting element is arranged on the outside of the edge area. The exposed area of the heat conducting element has, in particular, a contact surface that preferably abuts the printed circuit board of the battery pack device. Preferably, the outer surface of the edge area faces away from the battery cells and/or the battery cell contact section. Advantageously, a particularly simple and convenient assembly and disassembly of the temperature sensor elements can be carried out. Advantageously, a particularly convenient maintenance of the battery pack device can be realized. Advantageously, the temperature sensor element can be checked particularly easily and conveniently for, in particular, external damage.

It is also proposed that the heat conducting element is angled in the edge area. In particular, a main extension plane of the contact surface of the exposed area is at least substantially perpendicular to a main extension plane of the heat conducting element and/or a main extension plane of the battery cell contact section. By “substantially perpendicular” may be understood an orientation of a direction relative to a reference direction, wherein the direction and the reference direction, in particular as viewed in a projection plane, enclose an angle of 90° and the angle has a maximum deviation of in particular less than 8°, advantageously less than 5° and particularly advantageously less than 2°. Alternatively, it is also conceivable that the heat conducting element is formed in a straight line in the edge area, in particular free of an angled portion, wherein in particular the main extension plane of the contact surface of the exposed area of the heat conducting element runs at least substantially parallel to the main extension plane of the heat conducting element and/or the main extension plane of the battery cell contact section. Advantageously, the heat can be dissipated from the battery cell over a large area, in particular with a simultaneously compact design of the battery pack device. Advantageously, overheating of the battery cell can be counteracted particularly effectively. Advantageously, a particularly long lifetime of a battery cell can be achieved.

In addition, it is proposed that the temperature sensor element is arranged on a rigid printed circuit board, in particular in an alternative exemplary embodiment. Alternatively, it is conceivable that the printed circuit board of the battery pack device is designed as a rigid printed circuit board. Advantageously, a particularly rigidly constructed battery pack device can be provided for measuring the temperature of battery cells. Advantageously, a particularly precise positioning of the temperature sensor element, the heat conducting element and the printed circuit board of the battery pack device relative to each other can be achieved. Advantageously, a particularly precise and reliable temperature determination can be achieved by the temperature sensor element.

It is further proposed that the temperature sensor element is connected to a printed circuit board of the battery pack, in particular the further printed circuit board of the battery pack device, via a wire connection. In particular, the battery pack device has the wire connection. Advantageously, the battery pack device can be designed to be particularly flexible and compact. Advantageously, a particularly simple construction of the battery pack device, in particular with only one printed circuit board, can be made possible. Advantageously, a particularly low-cost battery pack device can be provided for temperature determination.

Furthermore, a battery pack with a battery pack device according to the disclosure is proposed. The battery pack preferably has a battery pack housing. In particular, the battery pack housing has the housing unit of the battery pack device. The battery pack is designed, for example, as a hand tool battery pack. Alternatively, however, it is also conceivable that the battery pack is designed as a different battery pack that appears reasonable to a person skilled in the art. Preferably, an area between the battery cells is free of sensor elements, in particular free of temperature sensor elements. In particular, the battery cell contact section of the heat conducting element extends at least substantially parallel to a main extension plane of the battery cell in at least one operating state. The term “substantially (in) parallel” should in particular in this context be understood to mean an orientation of a direction relative to a reference direction, in particular in a plane, wherein the direction has a deviation from the reference direction of in particular less than 8°, advantageously less than 5°, and particularly advantageously less than 2°. Preferably, the main extension plane of the heat conducting element is at least substantially parallel to the main extension plane of the battery cell in at least one operating state. The battery cell contact section is in particular a part of the heat conducting element which, viewed in a direction at least substantially perpendicular to the main extension plane of the heat conducting element, is covered by the battery cell in at least one operating state. In particular, the main extension plane of the heat conducting element is at least substantially parallel to the main extension plane of the battery cell contact section. Advantageously, a battery pack with a particularly compact design can be provided. Advantageously, additional elements such as connectors and cables for temperature measurement of the battery cells of the battery pack can be dispensed with at least in part. Advantageously, a particularly simple design of the battery pack can be realized. Advantageously, a particularly high reliability and quality of the battery pack can be achieved. Advantageously, damage caused by the temperature measuring unit, which can be generated when positioning the temperature sensor element between the battery cells during operation or due to inadequate mounting, can be avoided. Advantageously, a particularly high level of operational reliability can be achieved. Advantageously, the temperature of the battery cells can be monitored particularly easily, especially at low cost, and precisely. Advantageously, a service life of the battery cells can be increased.

The battery pack device according to the disclosure and/or the battery pack according to the disclosure shall/shall not be limited in this respect to the application and embodiment described above. In particular, the battery pack device according to the disclosure and/or the battery pack according to the disclosure may have a plurality of individual elements, components, and units that differs from a plurality of individual elements, components, and units described herein in order to fulfill a mode of operation described herein. Moreover, regarding the ranges of values indicated in this disclosure, values lying within the aforementioned limits are also intended to be considered as being disclosed and usable as desired.

### BRIEF DESCRIPTION OF THE DRAWINGS

Further advantages will become apparent from the following description of the drawing. The drawings illustrate an advantageous exemplary embodiment of the battery pack. The drawings, the description, and the claims contain numerous features in combination. A skilled person will appropriately also consider the features individually and combine them into additional advantageous combinations.

Shown are:

FIG. 1 a battery pack according to the disclosure with a battery pack device according to the disclosure in a schematic representation and

FIG. 2 the battery pack device according to the disclosure in a sectional view.

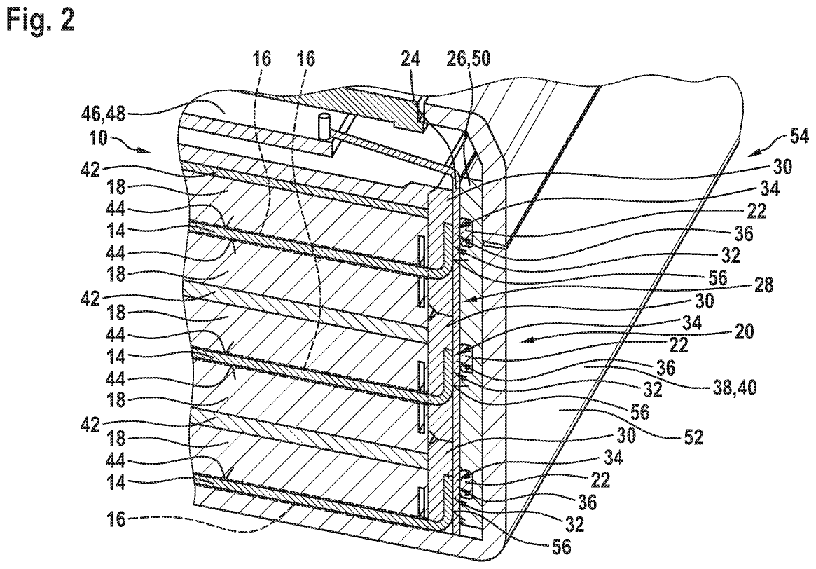

### DETAILED DESCRIPTION

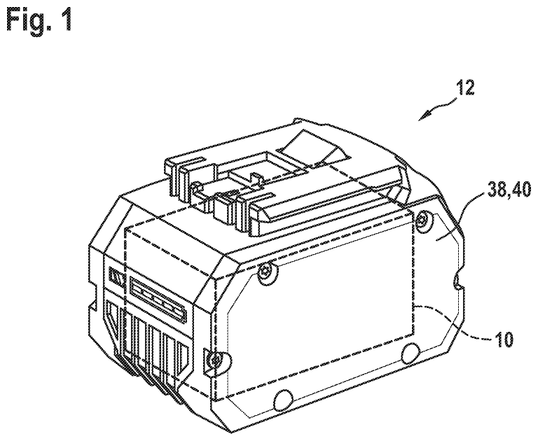

FIG. 1 shows a battery pack 12 with a battery pack device 10. The battery pack 12 has a battery pack housing 40. The battery pack 12 is designed as a hand tool battery pack. Alternatively, however, it is also conceivable that the battery pack 12 is formed as another battery pack which appears to a person skilled in the art to be useful. The battery pack 12 has a plurality of battery cells 18. The battery pack 12 is designed as a pouch cell battery pack. The battery cells 18 are designed as pouch cells. Alternatively, however, it is also conceivable that the battery pack 12 has only one battery cell 18. The battery pack 12, in particular the battery pack device 10, has a plurality of balancing elements 42. One of the balancing elements 42 is at least partially arranged between the battery cells 18. The compensation elements 42 are provided to compensate for manufacturing tolerances and/or changes in a thickness of the battery cells 18. The compensating elements 42 are formed, for example, as foam pads or the like.

The battery pack device 10 includes a plurality of heat conducting elements 14. Alternatively, however, it is also conceivable that the battery pack device 10 has only one heat conducting element 14. The heat conducting elements 14 are of plate-like design. The heat conducting elements 14 are designed as cooling plates, in particular as cooling sheets. Alternatively, however, it is also conceivable that the heat conducting elements 14 are strip-like or wire-like or have another shape that appears reasonable to a person skilled in the art. The heat conduction elements 14 each have a battery cell contact section 16 for arrangement on at least one of the battery cells 18, in particular between two battery cells 18, of the battery pack 12 and for dissipating heat from the at least one battery cell 18. The respective battery cell contact section 16 has at least one battery cell contact surface 44 that engages one of the battery cells 18 in at least one operating state. At least the battery cell contact sections 16 of the heat conducting elements 14 arranged between two battery cells 18 have two battery cell contact surfaces 44, each of which abuts one of the two battery cells 18.

The battery pack device 10 has at least one temperature measuring unit 20. The temperature measuring unit 20 has a plurality of temperature sensor elements 22. Alternatively, it is also conceivable that the temperature measuring unit 20 comprises only one temperature sensor element 22. The heat conducting elements 14 are each thermally coupled to at least one of the temperature sensor elements 22. A plurality of heat conducting elements 14 corresponds to a plurality of temperature sensor elements 22. One of the temperature sensor elements 22 is associated with each of the heat conducting elements 14. Alternatively, however, it is also conceivable that the plurality of heat conducting elements 14 is smaller or larger than the plurality of temperature sensor elements 22.

The temperature sensor elements 22 are arranged outside the respective battery cell contact section 16 of the heat conducting elements 14. The temperature sensor elements 22 are spaced apart from the battery cells 18 in at least one operating state. The temperature sensor elements 22 are spaced apart from the respective battery cell contact sections 16 of the heat conducting elements 14. The temperature sensor elements 22 are spaced apart from a respective main extension plane of the battery cell contact sections 16. Alternatively, it is also conceivable that the main extension planes of the battery cell contact sections 16 intersect the respective temperature sensor elements 22. The battery cell contact sections 16 are free of sensor elements, in particular free of temperature sensor elements 22.

The temperature measuring unit 20 has a computing unit (not shown here). The computing unit is connected to the temperature sensor elements 22 for signal transmission, preferably by cable. The computing unit is provided for determining a temperature of the battery cell 18 or battery cells 18 arranged at the respective heat conducting element 14 in dependence on a respective sensor signal of the temperature sensor elements 22. The computing unit comprises at least a processor and a storage element, as well as an operating program stored on the storage element. The storage element is designed as a digital storage medium, for example a hard drive or the like.

The battery pack device 10 includes a printed circuit board 24. The printed circuit board 24 of the battery pack device 10 is formed as a flexible circuit board. The printed circuit board 24 of the battery pack device 10 is arranged between the heat conducting elements 14 and the temperature sensor elements 22. The temperature sensor elements 22 are spaced apart from the heat conducting elements 14. The temperature sensor elements 22 are thermally coupled to the respective heat conducting element 14 by means of the printed circuit board 24 of the battery pack device 10. The temperature sensor elements 22 are each arranged directly on the respective heat conducting element 14 as an alternative to thermal coupling with the heat conducting elements 14, for example by pressing or the like. Alternatively, however, it is also conceivable that the temperature sensor elements 22 are thermally coupled indirectly to the heat conduction elements 14, for example by means of a heat conduction paste or the like. The heat conducting elements 14 and the temperature sensor elements 22 are arranged on opposite sides of the printed circuit board 24 of the battery pack device 10. Alternatively, however, it is also conceivable that the heat conducting elements 14 and the temperature sensor elements 22 are arranged on the same side of the printed circuit board 24 of the battery pack device 10. In particular, it is alternatively conceivable that the temperature sensor element 22 is arranged between the heat conducting elements 14 and the printed circuit board 24 of the battery pack device 10.

The battery pack device 10 includes another printed circuit board 48. The printed circuit board 24 of the battery pack device 10 and the further circuit board 48 are arranged on different sides of the battery pack device 10 from each other. Alternatively, however, it is conceivable that the printed circuit board 24 of the battery pack device 10 and the further printed circuit board 48 are arranged on the same side. The further printed circuit board 48 is designed as a rigid printed circuit board. Alternatively, however, it is also conceivable that the further printed circuit board 48 is designed as a flexible printed circuit board. The further printed circuit board 48 is data connected to the printed circuit board 24 of the battery pack device 10. It is conceivable that the further printed circuit board 48 comprises, at least in part, the computing unit. The further printed circuit board 48 corresponds to a printed circuit board 46 of the battery pack 12.

Alternatively, however, it is also conceivable that the printed circuit board 24 of the battery pack device 10 is formed as a rigid printed circuit board, with the temperature sensor elements 22 being arranged on the rigid printed circuit board. Further, it is alternatively conceivable that the temperature sensor elements 22 are connected to the printed circuit board 46 of the battery pack 12 via a wire connection. It is conceivable that the printed circuit board 24 may include, at least in part, the computing unit.

The battery pack device 10 has a support unit 26 for supporting a temperature measurement by the temperature measuring unit 20. The support unit 26 is arranged on a side 28 of the printed circuit board 24 of the battery pack device 10 facing away from the heat conducting elements 14. The support unit 26 and the temperature sensor elements 22 are arranged on the same side of the printed circuit board 24 of the battery pack device 10. The support unit 26 is provided for fixed positioning of the temperature sensor elements 22 relative to the printed circuit board 24 of the battery pack device 10 and/or the heat conducting elements 14. The temperature sensor elements 22 are arranged between the heat conducting elements 14 and the support unit 26. The respective heat conducting element 14 and the support unit 26 together at least substantially completely enclose the respective temperature sensor element 22 in at least one operating state.

The support unit 26 is elastic to generate a contact force for the temperature sensor elements 22 in the direction of the heat conducting elements 14. The support unit 26 has at least one support element 50. The support unit 26, in particular the support element 50, is formed from a foam material. Alternatively, however, it is also conceivable that the support unit 26, in particular the support element 50, is formed from a rubber-elastic material or the like. The support element 50 is of a plate-like design. Alternatively, however, it is also conceivable that the support element 50 is circular-cylindrical, spherical, cuboidal, in particular cube-shaped, or the like. The support unit 26, in particular the support element 50, has a modulus of elasticity between 0.1 MPa and 400 MPa. The battery pack device 10 includes at least one housing unit 38. The battery pack housing 40 has the housing unit 38 of the battery pack device 10. The heat conducting elements 14, the battery cells 18, the temperature measuring unit 20, and/or the support unit 26 are at least substantially entirely arranged within the housing unit 38 of the battery pack device 10. The support unit 26, in particular the support element 50, is arranged between the housing unit 38, in particular a housing element 52 of the housing unit 38, and the printed circuit board 24 of the battery pack device 10.

The support unit 26 is thermally insulated from an external environment to thermally insulate the temperature sensor elements 22. The support unit 26, in particular the support element 50, has a thermal conductivity of at most 0.3 W(K·m). The outdoor environment is arranged on a side 54 of the support unit 26 facing away from the temperature sensor elements 22.

The battery pack device 10 includes a plurality of cell holders 30 for arranging the battery cells 18. The heat conducting elements 14 are each partially overmolded by at least one of the cell holders 30. Alternatively, however, it is also conceivable that the battery pack device 10 comprises only a cell holder 30. The heat conducting elements 14 are preferably partially overmolded by the cell holders 30 by an injection molding process. The heat conducting elements 14 are formed of aluminum. Alternatively, however, it is also conceivable that the heat conducting elements 14 are formed from a plastic with a thermal conductivity of more than 0.3 W(K·m). The heat conducting elements 14 each have an exposed area 32 in which the heat conducting elements 14 are each free from being overmolded by the cell holders 30. The cell holders 30 are arranged between the exposed areas 32 and the battery cell contact sections 16. The cell holders 30 are arranged between the exposed areas 32 and the battery cells 18.

The heat conducting elements 14 are designed to be exposed in a direction facing away from the battery cells 18, in particular free of an encapsulation by a cell holder 30. The temperature sensor elements 22 are arranged in the respective exposed area 32 of the heat conducting elements 14. The printed circuit board 24 of the battery pack device 10 is arranged in the exposed areas 32 of the heat conducting elements 14. The exposed areas 32 are spaced apart from the battery cells 18 and/or the battery cell contact sections 16 in at least one operating state.

The heat conducting elements 14 each have an edge area 34. The edge areas 34 are arranged outside the battery cell contact sections 16. The temperature sensor elements 22 are arranged at the respective edge area 34 of the heat conducting elements 14. The exposed areas 32 of the heat conducting elements 14 are arranged in the respective edge area 34 of the heat conducting elements 14. The temperature sensor elements 22 are arranged on an outer surface 36 of the respective edge area 34. The respective exposed area 32 of the heat conducting elements 14 is arranged on the outer sides 36 of the edge areas 34. The exposed areas 32 of the heat conducting elements 14 each include a contact surface 56 that abuts the printed circuit board 24 of the battery pack device 10. The outer sides 36 of the edge areas 34 face away from the battery cells 18 and/or the battery cell contact sections 16.

The heat conducting elements 14 are angled in the respective edge area 34. A respective main extension plane of the contact surfaces 56 of the exposed areas 32 is at least substantially perpendicular to main extension planes of the heat conducting elements 14 and/or main extension planes of the battery cell contact sections 16. Alternatively, it is also conceivable that the heat conducting elements 14 are formed straight in the respective edge area 34, in particular free of an angled portion, wherein in particular the main extension planes of the contact surfaces 56 of the exposed areas 32 of the heat conducting elements 14 extend at least substantially parallel to the main extension planes of the heat conducting elements 14 and/or the main extension planes of the battery cell contact sections 16.

An area between the battery cells 18 is free of sensor elements, in particular free of temperature sensor elements 22. In at least one operating state, the battery cell contact sections 16 of the heat conducting elements 14 extend at least substantially parallel to main extension planes of the battery cells 18. The main extension planes of the heat conducting elements 14 extend at least substantially parallel to the main extension planes of the battery cells 18 in at least one operating state. The battery cell contact sections 16 are each a part of the respective heat conducting element 14, which is covered by one of the battery cells 18 when viewed in a direction at least substantially perpendicular to the main extension plane of the respective heat conducting element 14 in at least one operating state. The main extension planes of the heat conducting elements 14 are at least substantially parallel to the main extension planes of the battery cell contact sections 16.

1. A battery pack device for a battery pack, comprising:
at least one heat conducting element which has at least one battery cell contact section configured to be arranged on at least one battery cell of the battery pack and configured to dissipate heat from the at least one battery cell; and
at least one temperature measuring unit which has at least one temperature sensor element thermally coupled to the heat conducting element,
wherein the temperature sensor element is arranged outside the at least one battery cell contact section of the heat conducting element.

2. The battery pack device according to claim 1, further comprising:
a printed circuit board arranged between the heat conducting element and the temperature sensor element.

3. The battery pack device according to claim 2, further comprising:
a support unit configured to support a temperature measurement by the temperature measuring unit, the support unit being arranged on a side of the printed circuit board facing away from the heat conducting element.

4. The battery pack device according to claim 3, wherein the support unit is elastically formed so as to generate a contact force for the temperature sensor element in a direction of the heat conducting element.

5. The battery pack device according to claim 3, wherein the support unit is thermally insulating so as to thermally insulate the temperature sensor element from an external environment.

6. The battery pack device according to claim 1, further comprising:
at least one cell holder in which the at least one battery cell is arranged,
wherein the heat conducting element is partially overmolded in the cell holder.

7. The battery pack device according to claim 6, wherein:
the heat conducting element is configured to be exposed in a direction facing away from the at least one battery cell, and
the temperature sensor element is arranged in an exposed area of the heat conducting element.

8. The battery pack device according to claim 1, wherein the heat conducting element has an edge area at which the temperature sensor element is arranged.

9. The battery pack device according to claim 8, wherein the temperature sensor element is arranged on an outer surface of the edge area.

10. The battery pack device according to claim 8, wherein the heat conducting element is arranged at an angle in the edge area.

11. The battery pack device according to claim 1, wherein the temperature sensor element is arranged on a rigid printed circuit board.

12. The battery pack device according to claim 1, wherein the temperature sensor element is connected to a printed circuit board of the battery pack via a wire connection.

13. A battery pack comprising:
one or more battery cells; and
a battery pack device comprising:
at least one heat conducting element which has at least one battery cell contact section configured to be arranged on at least one battery cell of the one or more battery cells and configured to dissipate heat from the at least one battery cell; and
at least one temperature measuring unit which has at least one temperature sensor element thermally coupled to the heat conducting element,
wherein the temperature sensor element is arranged outside the at least one battery cell contact section of the heat conducting element.

14. The battery pack according to claim 13, wherein the battery pack is a pouch cell battery pack.

15. The battery pack device according to claim 1, wherein the at least one battery cell contact section is configured to be arranged between two battery cells of the at least one battery cell.

16. The battery pack device according to claim 2, wherein the printed circuit board is a flexible printed circuit board.
